(19) United States
(12) Patent Application Publication
(10) Pub. No.: US 2025/0296120 A1
(43) Pub. Date: Sep. 25, 2025

(54) POWER DRILL ATTACHMENT APPARATUS AND SYSTEM

(71) Applicant: JS2 Enterprises, LLC, Easley, SC (US)

(72) Inventor: Justin Spalding, Easley, SC (US)

(21) Appl. No.: 19/083,312

(22) Filed: Mar. 18, 2025

Related U.S. Application Data
(60) Provisional application No. 63/567,353, filed on Mar. 19, 2024.

(51) Int. Cl. B08B 3/02; B23B 45/00

(52) U.S. Cl. CPC B08B 3/026; B08B 2203/0223; B08B 2203/0247; B08B 2203/027; B23B 45/003

(57) ABSTRACT

The present disclosure relates to the field of power drill accessories; in particular, a plurality of drill-powered tools for use in a variety of home and construction-related applications. Certain aspects of the present disclosure provide for a drill-powered apparatus comprising a hex shank configured to be selectively coupled to a chuck of a power drill; a drive assembly operably engaged with the hex shank, wherein the drive assembly is configured to be rotatably engaged via the hex shank; and at least one functional component operably engaged with the drive assembly, wherein the at least one functional component is configured to perform at least one function in response to rotation of the drive assembly.

### CROSS-REFERENCE TO RELATED APPLICATIONS

The present application claims the benefit of and priority to U.S. provisional patent application Ser. No. 63/567,353, entitled “POWER DRILL ATTACHMENT APPARATUS AND SYSTEM” and having a filing date of Mar. 19, 2024; the contents of which are incorporated herein in their entirety at least by virtue of this reference.

### FIELD

The present disclosure relates to the field of power drill accessories; in particular, a power drill apparatus and system for use in a variety of home or construction-related applications.

### BACKGROUND

Cordless drills and power drills are widely available, highly versatile tools that provide significant rotational force. Given their ubiquity in both professional and household settings, there exists an opportunity to leverage their power for various applications. Some attempts have been made to attach different accessories to drills, but existing solutions often suffer from inefficiencies, instability, or limited compatibility with different drill models.

Through applied effort, ingenuity, and innovation, Applicant has identified a number of deficiencies and problems with power drill accessories and attachments. Applicant has developed a solution that is embodied by the present invention, which is described in detail below.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Certain aspects of the present disclosure provide for a power cleaner apparatus comprising a housing portion; a pump casing housed inside the housing portion, wherein the pump casing comprises a water inlet, a water outlet and an internal chamber configured to receive a volume of water therein; a hose connector portion coupled to the housing portion, wherein the hose connector portion is configured to deliver a flow of water to the internal chamber of the pump casing; a hex shank extending through a surface of the housing portion, wherein the hex shank is configured to interface with a chuck of a power drill, wherein the hex shank is configured to rotate 360 degrees in response to rotary motion applied by the power drill; an impeller operably engaged with the hex shank and housed in the internal chamber of the pump casing, wherein the hex shank is configured to rotate the impeller 360 degrees, wherein the impeller is configured to force the volume of water from the internal chamber of the pump casing through the water outlet when the impeller is rotated by the hex shank; and a nozzle portion comprising a channel portion extending from a first end to a second end, wherein the nozzle portion is coupled to the housing portion and configured to receive a pressurized flow of water from the water outlet of the pump casing at the first end and output the pressurized flow of water at the second end.

In accordance with certain embodiments, the power cleaner apparatus may further comprise a water tube removably coupled to the hose connector portion. In certain embodiments, the nozzle portion further comprises a radial dial disposed on the second end and comprising a plurality of different nozzles configured to receive the pressurized flow of water therethrough. In certain embodiments, each nozzle in the plurality of different nozzles may comprise a different spray pattern. In certain embodiments, the hex shank comprises a retaining groove configured to interface with an impact driver. In certain embodiments, the impeller is configured to generate a negative pressure at the water inlet of the pump casing when rotated by the hex shank. In certain embodiments, the impeller is configured to generate a variable pressure in the internal chamber of the pump casing according to a speed of rotation of the hex shank. In certain embodiments, the hex shank comprises a size in the range of a one-quarter inch hex to a three-eighths inch hex. In certain embodiments, the nozzle portion is removably coupled to the housing portion via a mateable interface.

Further aspects of the present disclosure provide for a power cleaner system comprising an apparatus comprising a housing portion; a pump casing housed inside the housing portion, wherein the pump casing comprises a water inlet, a water outlet and an internal chamber configured to receive a volume of water therein; a hose connector portion coupled to the housing portion, wherein the hose connector portion is configured to deliver a flow of water to the internal chamber of the pump casing; a hex shank extending through a surface of the housing portion; an impeller operably engaged with the hex shank and housed in the internal chamber of the pump casing, wherein the hex shank is configured to rotate the impeller 360 degrees, wherein the impeller is configured to force the volume of water from the internal chamber of the pump casing through the water outlet when the impeller is rotated by the hex shank; and a nozzle portion comprising a channel portion extending from a first end to a second end, wherein the nozzle portion is coupled to the housing portion and configured to receive a pressurized flow of water from the water outlet of the pump casing at the first end and output the pressurized flow of water at the second end; and a power drill comprising a chuck configured to receive and retain the hex shank, wherein the power drill is configured to rotate the hex shank via a rotational drive at the chuck.

In accordance with certain embodiments, the power cleaner apparatus may further comprise a water tube removably coupled to the hose connector portion. In certain embodiments, the nozzle portion further comprises a radial dial disposed on the second end and comprising a plurality of different nozzles configured to receive the pressurized flow of water therethrough. In certain embodiments, each nozzle in the plurality of different nozzles comprises a different spray pattern. In certain embodiments, the hex shank comprises a retaining groove configured to interface with an impact driver. In certain embodiments, the impeller is configured to generate a negative pressure at the water inlet of the pump casing when rotated by the hex shank. In certain embodiments, the impeller is configured to generate a variable pressure in the internal chamber of the pump casing according to a speed of rotation of the hex shank. In certain embodiments, the hex shank comprises a size in the range of a one-quarter inch hex to a three-eighths inch hex. In certain embodiments, the nozzle portion is removably coupled to the housing portion via a mateable interface. In certain embodiments, the hose connector portion comprises a quick connect garden hose fitting.

Still further aspects of the present disclosure provide for a power cleaner apparatus comprising a housing portion comprising a water inlet, a water outlet and an internal chamber configured to receive a volume of water therein; a hex shank extending through a surface of the housing portion, wherein the hex shank is configured to interface with a chuck of a power drill, wherein the hex shank is configured to rotate 360 degrees in response to rotary motion applied by the power drill; an impeller operably engaged with the hex shank and housed in the internal chamber of the housing portion, wherein the hex shank is configured to rotate the impeller 360 degrees, wherein the impeller is configured to force the volume of water from the internal chamber of the housing portion through the water outlet when the impeller is rotated by the hex shank; and a nozzle portion coupled to the housing portion and configured to direct a pressurized flow of water from the water outlet at a nozzle tip.

Certain objects and advantages of the present disclosure include a drill-powered grill brush comprising a hex shank configured to interface with the chuck of a power drill or impact driver. In accordance with certain aspects of the present disclosure, the drill-powered grill brush comprises a housing, a grill brush portion, a handle, and a brush guard. The hex shank may be configured to drive a gear assembly configured to rotate the grill brush portion around an axis in response to rotation of the hex shank via the power drill.

Certain objects and advantages of the present disclosure include a drill-powered caulk gun comprising a hex shank portion extending from a proximal end of a threaded shaft. The drill-powered caulk gun may comprise a body portion configured to receive and retain a caulk tube. The drill-powered caulk gun may comprise a plunger coupled to the distal end of the threaded shaft. In certain embodiments, drill-powered caulk gun may comprise a threaded drive at a proximal end of the body portion. The threaded drive may comprise a release mechanism configured to free the threaded shaft from the threaded drive. In accordance with certain aspects of the present disclosure, the hex shank portion is configured to interface with the chuck of a power drill or impact driver. The hex shank portion is configured to rotate the threaded shaft in response to rotational motion by the power drill or impact driver. The rotational motion is configured to drive the threaded shaft via the threaded drive to move the plunger.

Certain objects and advantages of the present disclosure include a drill-powered tire pressure pump. The drill-powered tire pressure pump may comprise a hex shank portion configured to interface with a chuck of a power drill or impact driver. The hex shank portion may be operably engaged with a gear assembly configured to drive a piston to create a pressurized flow of air via a hose of the drill-powered tire pressure pump.

Certain objects and advantages of the present disclosure include a scrubbing apparatus comprising a hex shank configured to interface with a chuck of a power drill or impact driver.

Certain objects and advantages of the present disclosure include a painting tool comprising a hex shank portion configured to interface with a chuck of a power drill or impact driver. The painting tool may comprise a first removable portion configured for mixing paint. The painting tool may comprise a second removable portion configured to receive and retain a paint roller. The painting tool may comprise a third removable portion configured to receive and retain a paint brush. The painting tool may be rotated around an axis of the hex shank portion in response to rotational force by the power drill or impact driver. The rotational motion may enable one or more functions of the painting tool, including paint mixing, paint roller cleaning and paint brush cleaning.

The foregoing has outlined rather broadly the more pertinent and important features of the present invention so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present invention. It should be realized by those skilled in the art that such equivalent structures do not depart from the spirit and scope of the invention as set forth in the appended claims.

### BRIEF DESCRIPTION OF DRAWINGS

The skilled artisan will understand that the figures, described herein, are for illustration purposes only. It is to be understood that in some instances various aspects of the described implementations may be shown exaggerated or enlarged to facilitate an understanding of the described implementations. In the drawings, like reference characters generally refer to like features, functionally similar and/or structurally similar elements throughout the various drawings. The drawings are not necessarily to scale, emphasis instead being placed upon illustrating the principles of the teachings. The drawings are not intended to limit the scope of the present teachings in any way. The apparatus and system may be better understood from the following illustrative description with reference to the following drawings in which:

FIG. 1A is a perspective view of a grill brush apparatus for a power drill, in accordance with certain aspects of the present disclosure;

FIG. 1B is a perspective view of the grill brush apparatus with a brush portion removed;

FIG. 1C is a component view of the grill brush apparatus;

FIG. 1D is a functional view of a power drill system comprising a grill brush apparatus, in accordance with certain aspects of the present disclosure;

FIG. 2A is a perspective view of a power cleaner apparatus for a power drill, in accordance with certain aspects of the present disclosure;

FIGS. 2B-2C are component views of the power cleaner apparatus;

FIG. 2D is a perspective view of a power cleaner nozzle for the power cleaner apparatus;

FIG. 2E is a perspective view of a spray selector dial for the power cleaner nozzle;

FIG. 2F is a perspective view of a face portion of the power cleaner nozzle;

FIG. 2G is a functional view of a power drill system comprising a power cleaner apparatus, in accordance with certain aspects of the present disclosure;

FIG. 3A is a perspective view of a caulk gun apparatus for a power drill, in accordance with certain aspects of the present disclosure;

FIGS. 3B-3D are component views of the caulk gun apparatus;

FIG. 3E is a functional view of a power drill system comprising a caulk gun apparatus, in accordance with certain aspects of the present disclosure;

FIG. 4A is a perspective view of a tire inflator pump apparatus for a power drill, in accordance with certain aspects of the present disclosure;

FIG. 4B is a component view of the tire inflator pump apparatus;

FIG. 4C is a functional view of a power drill system comprising a tire inflator pump apparatus, in accordance with certain aspects of the present disclosure;

FIGS. 5A-5B are perspective views of a scrubbing pad apparatus for a power drill, in accordance with certain aspects of the present disclosure;

FIG. 5C is a functional view of a power drill system comprising a scrubbing pad apparatus, in accordance with certain aspects of the present disclosure;

FIG. 6A is a perspective view of a painting tool apparatus for a power drill, in accordance with certain aspects of the present disclosure;

FIGS. 6B-6G are component views of the painting tool apparatus; and

FIG. 6H is a functional view of a power drill system comprising a painting tool apparatus, in accordance with certain aspects of the present disclosure.

### DETAILED DESCRIPTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout. All definitions, as defined and used herein, should be understood to control over dictionary definitions, definitions in documents incorporated by reference, and/or ordinary meanings of the defined terms.

Following below are more detailed descriptions of various concepts related to, and embodiments of, inventive methods, devices and systems comprising a plurality of drill-powered accessories for use in a variety of home or construction-related applications. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes. The present disclosure should in no way be limited to the exemplary implementation and techniques illustrated in the drawings and described below.

Where a range of values is provided, it is understood that each intervening value, to the tenth of the unit of the lower limit unless the context clearly dictates otherwise, between the upper and lower limit of that range and any other stated or intervening value in that stated range is encompassed by the invention. The upper and lower limits of these smaller ranges may independently be included in the smaller ranges, and are also encompassed by the invention, subject to any specifically excluded limit in a stated range. Where a stated range includes one or both of the endpoint limits, ranges excluding either or both of those included endpoints are also included in the scope of the invention.

As used herein, “exemplary” means serving as an example or illustration and does not necessarily denote ideal or best.

As used herein, the term “includes” means includes but is not limited to, the term “including” means including but not limited to. The term “based on” means based at least in part on.

As used herein, the term “interface” refers to any shared boundary across which two or more separate components of a computer system may exchange information. The exchange can be between software, computer hardware, peripheral devices, humans, and combinations thereof. The term “interface” may be further defined as any shared boundary or connection between two dissimilar objects, devices or systems through which information or power is passed and/or a mechanical, functional and/or operational relationship is established and/or accomplished. Such shared boundary or connection may be physical, electrical, logical and/or combinations thereof.

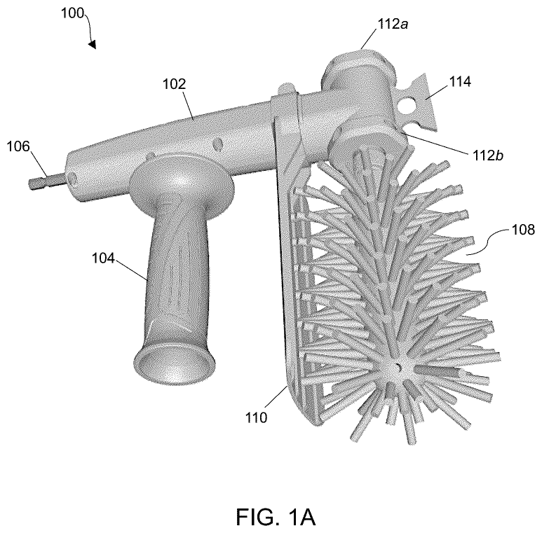

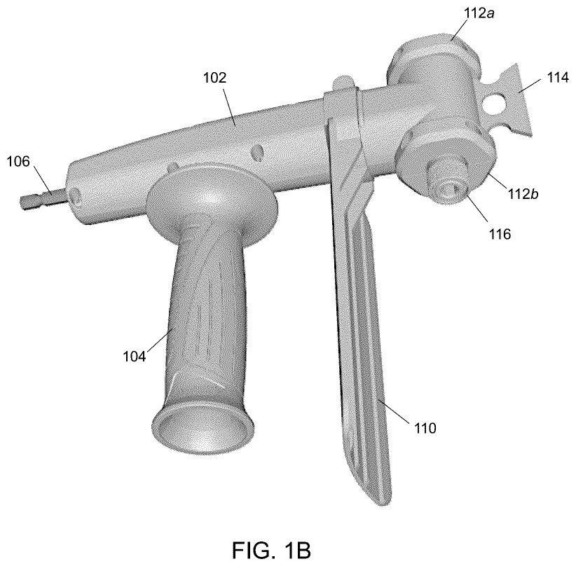

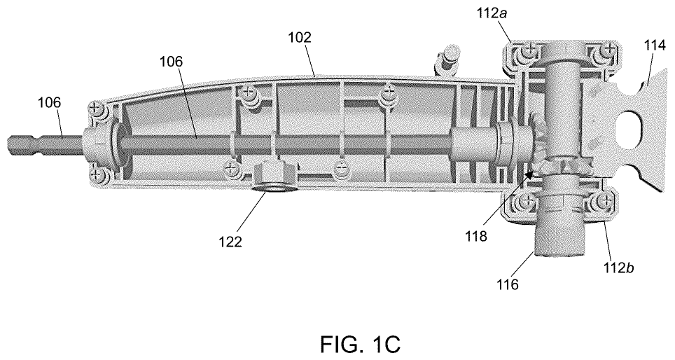

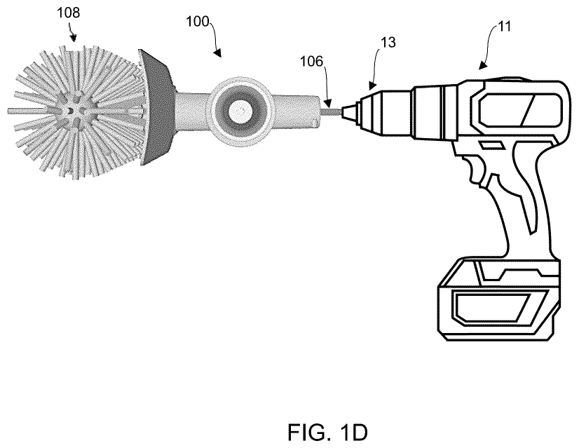

Turning now descriptively to the drawings, in which similar reference characters denote similar elements throughout the several views, FIG. 1A depicts a perspective view of a grill brush apparatus 100 for a power drill. In accordance with certain aspects of the present disclosure, apparatus 100 may comprise a body portion 102, a handle 104, a hex shank 106, a brush portion 108, a brush guard 110, a first bumper portion 112a and a second bumper portion 112b, and a scraper 114. As shown in FIG. 1B, brush portion 108 may be removably interfaced with a quick-connect mechanism 116. Brush portion 108 may comprise a plurality of hard bristles; e.g., the types of bristles commonly used in conventional grill brushes. In certain embodiments, first bumper portion 112a and second bumper portion 112b may comprise raised portions disposed on a distal end of body portion 102 configured to prevent body portion 102 from coming in direct contact with a grilling surface. Scraper 114 may comprise a metal piece configured to scrape a surface of a grill. Handle 104 may also be removable from body portion 102 via a threaded interface (e.g., nut 122 shown in FIG. 1C) or quick-connect mechanism. Brush guard 110 may be removable from body portion 102 via a thumb-drive screw or other mechanical interface. Hex shank 106 may comprise a retaining groove configured to interface with a quick-connect mechanism of an impact driver. Hex shank 106 may comprise a size in the range of a one-quarter inch hex to a three-eighths inch hex in order to accommodate a standard interface with commercial-off-the-shelf power drills and impact drivers.

FIG. 1C illustrates apparatus 100 with a portion of body portion 102 to reveal an internal assembly of apparatus 100. As shown in FIG. 1C, hex shank 106 may extend through an internal area of body portion 102 and interface with a gear assembly 118. Gear assembly 118 may comprise a right-angle gear assembly configured to rotate a spindle 120 around an axis. As shown in FIG. 1C, quick-connect mechanism 116 is coupled to spindle 120 such that quick-connect mechanism 116 is configured to rotate around the axis of spindle 120 when gear assembly 118 is engaged by hex shank 106. As shown in FIG. 1D, apparatus 100 may be operably engaged with a chuck 13 of power drill 11 to comprise a system. In accordance with certain aspects of the present disclosure, power drill 11 is configured to rotate hex shank 106 when power drill 11 is engaged in a mode of operation. Hex shank 106 is configured to drive gear assembly 118 in order to rotate spindle 120. Spindle 120 thereby rotates quick-connect mechanism 116, which thereby rotates brush portion 108 around an axis. The rotational movement of brush portion 108 creates a cleaning action, which a user may then apply to a grilling surface of a barbeque grill in order to clean said surface.

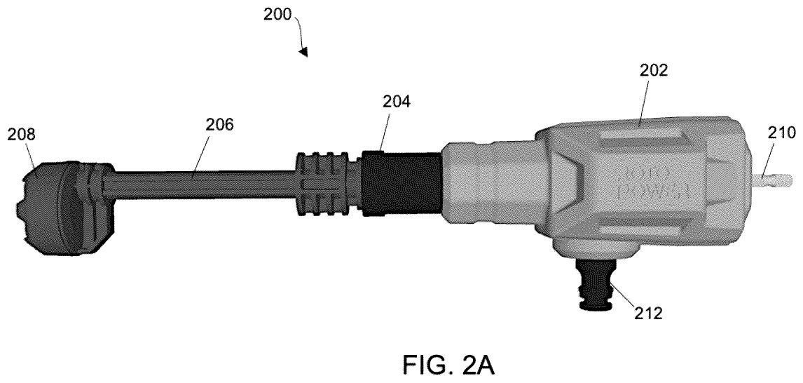

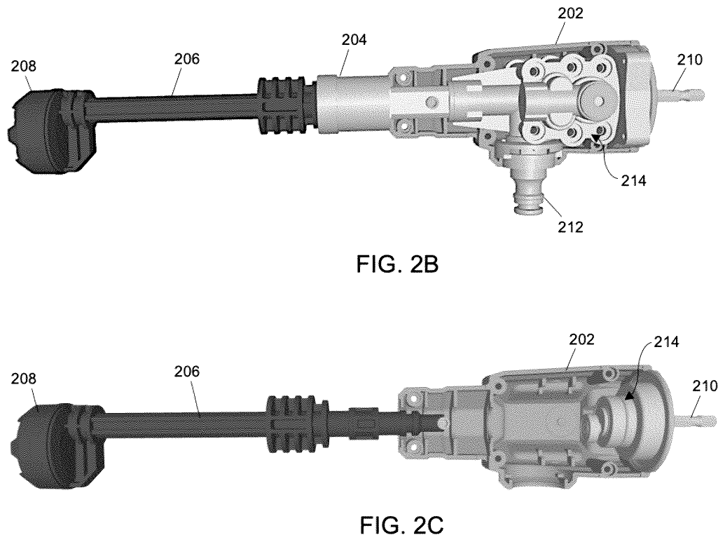

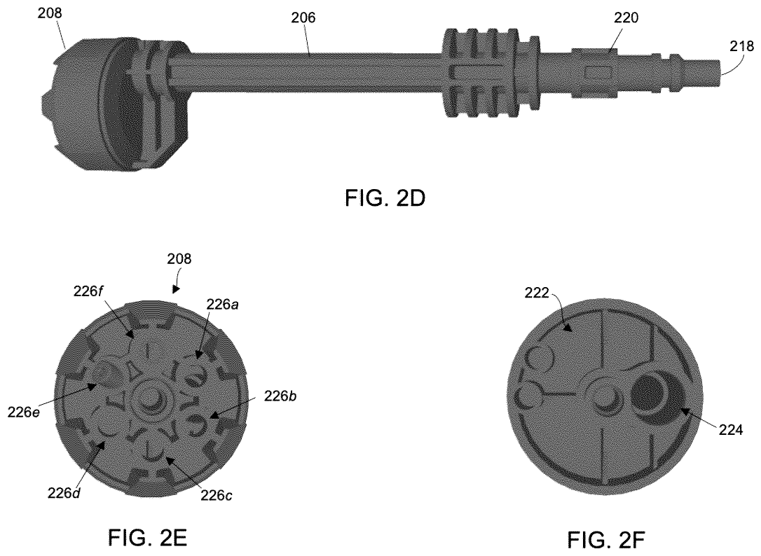

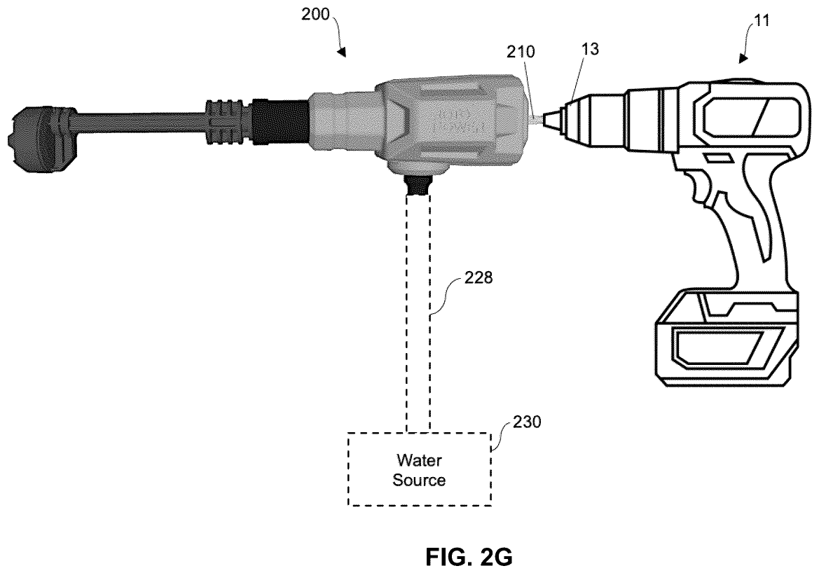

Referring now to FIGS. 2A-2G, a perspective view of a power cleaner apparatus 200 is shown. In accordance with certain aspects of the present disclosure, apparatus 200 is configured to operably interface with a power drill or impact driver via a hex shank 210. In certain embodiments, hex shank 210 comprises a retaining groove configured to interface with a quick-connect mechanism of an impact driver. Hex shank 210 may comprise a size in the range of a one-quarter inch hex to a three-eighths inch hex in order to accommodate a standard interface with commercial-off-the-shelf power drills and impact drivers. In accordance with certain embodiments, apparatus 200 comprises a housing portion 202, a nozzle connector portion 204, a nozzle 206, a nozzle tip selector dial 208, a hex shank 210, and a hose connector 212. As shown in FIG. 2B, apparatus 200 may comprise a pump casing 214 housed inside housing portion 202. Pump casing 214 may be communicably engaged with hose connector 212 to receive a flow of water via a water inlet of pump casing 214. Pump casing 214 may comprise an internal chamber configured to receive a volume of water therein and a water outlet communicably engaged with nozzle 206. As shown in FIG. 2C, hex shank 210 may extend through a surface of housing portion 202. Apparatus 200 may further comprise an impeller 216 operably engaged with hex shank 210. In accordance with certain embodiments, impeller 216 is housed in the internal chamber of pump casing 214. In accordance with certain embodiments, hex shank 210 is configured to rotate impeller 216 360-degrees around an axis of hex shank 210. In accordance with certain aspects of the present disclosure, the rotational motion of impeller 216 is configured to generate pressure inside the internal chamber of pump casing 214 and force a volume of water from the internal chamber of pump casing 214 through the water outlet of pump casing 214 when the impeller 216 is rotated by the hex shank 210.

As shown in more detail in FIGS. 2D-2F, nozzle 206 may comprise a water channel extending between a first opening 218 and a second opening 224. In certain embodiments, nozzle 206 may comprise an interface portion 220 disposed on a proximal end of nozzle 206 and configured to mateably interface with nozzle connector portion 204; e.g., such that nozzle 206 may be selectively coupled to and removed from housing portion 202. As shown in FIGS. 2B-2C, the first opening 218 of nozzle 206 may be communicably engaged with the water outlet of pump casing 214 to receive a pressurized flow of water therefrom. As shown in FIG. 2F, nozzle 206 may comprise a face portion 222. Face portion 222 may be circular in shape and may comprise a substantially planar surface. The second opening 224 may be disposed on face portion 222 and is configured to output the pressurized flow of water therefrom. In certain embodiments, nozzle tip selector dial 208 may be rotatably coupled to a surface of face portion 222. In accordance with certain embodiments, nozzle tip selector dial 208 may comprise a plurality of nozzle tips 226a-226f. In accordance with certain embodiments, each nozzle tip in the plurality of nozzle tips 226a-226f comprises a different spray pattern. In accordance with certain aspects of the present disclosure, a user may rotate nozzle tip selector dial 208 to align a desired nozzle tip with the second opening 224. The pressurized flow of water from second opening 224 is thereby forced through an opening of the desired nozzle tip. Each nozzle tip in the plurality of nozzle tips 226a-226f may be configured to restrict the flow of water therethrough in order to increase the pressure of the water output and/or direct the water output into a specific spray pattern.

As shown in FIG. 2G, apparatus 200 may be operably engaged with power drill 11 via an interface between hex shank 210 and chuck 13 to comprise a system. In accordance with certain aspects of the present disclosure, power drill 11 is configured to rotate hex shank 210 in accordance with an operational mode of power drill 11. As discussed in FIGS. 2B-2C, hex shank 210 is configured to rotate impeller 216 (as shown in FIG. 2C) in order to create pressure in the internal chamber of pump casing 214 (as shown in FIG. 2B). In accordance with certain aspects of the present disclosure, impeller 216 is configured to generate a negative pressure at the water inlet of pump casing 214 (e.g., to draw water therefrom) and generate a positive pressure the water outlet of pump casing 214 (e.g., to expel water therefrom). In accordance with certain aspects of the present disclosure, impeller 216 is configured to generate a variable pressure inside pump casing 214 according to a rotation speed of power drill 11. As shown in FIG. 2G, a drill-powered power cleaner system may further comprise a hose 228 and a water source 230. Hose 228 may comprise a garden hose or other tubing. Hose 228 may be selectively coupled to hose connector 212. In certain embodiments, hose connector 212 may comprise a quick-connect garden hose connector. Hose 228 is configured to deliver a flow of water to pump casing 214 via hose connector 212. In accordance with certain aspects of the present disclosure, water source 230 may comprise a pressurized water source (e.g., an outdoor spigot) or an unpressurized water source, such as a bucket of water. In cases where the drill-powered power cleaner system is used with an unpressurized water source, apparatus 200 is configured to generate negative pressure at hose 228 such that hose 228 is configured to draw water up from water source 230 and deliver it to the internal chamber of pump casing 214.

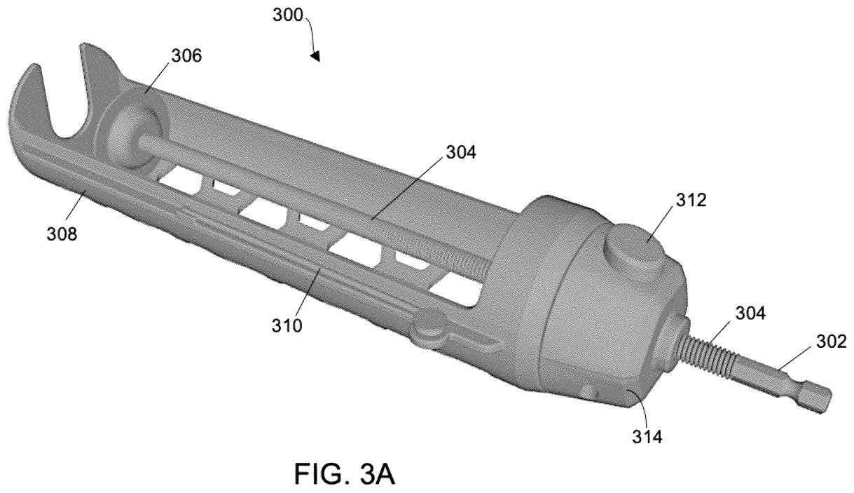

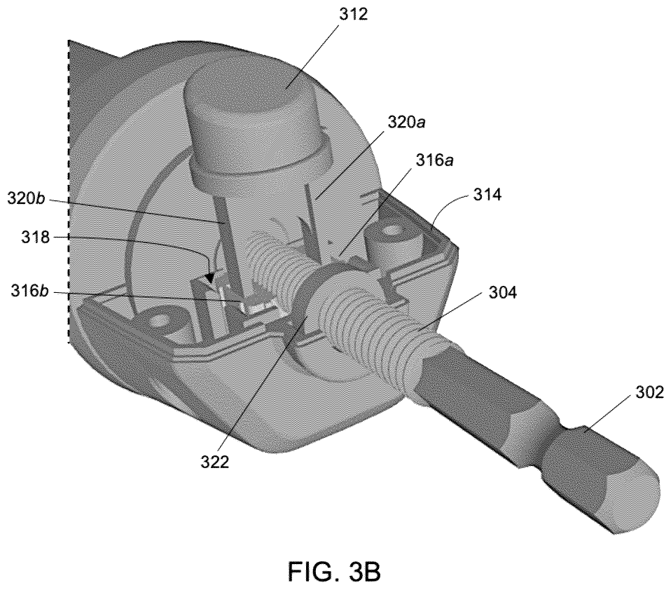

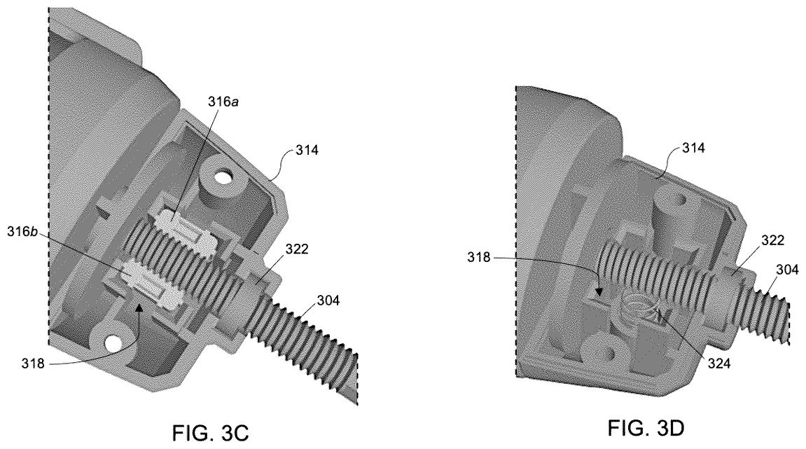

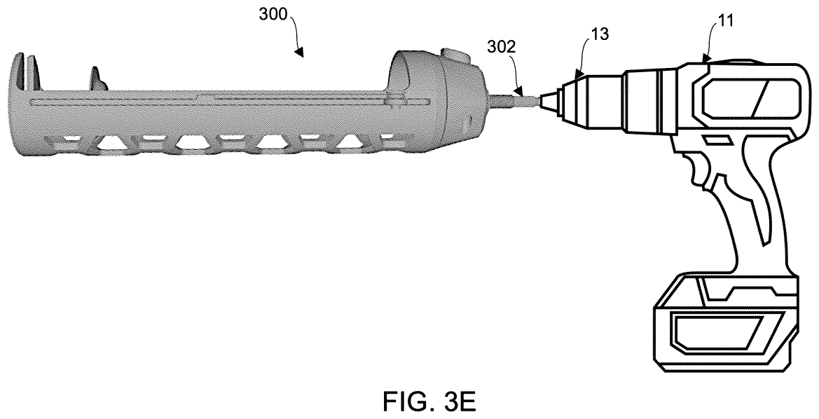

Referring now to FIGS. 3A-3E, a perspective view of a drill-powered caulk gun apparatus 300 is shown. In accordance with certain aspects of the present disclosure, apparatus 300 comprises a hex shank 302, a threaded shaft 304, a plunger 306 coupled to a distal end of threaded shaft 304, a body portion 308, a puncture tool 310, a release button 312 and an assembly housing 314. As shown in FIG. 3B, assembly housing 314 houses a drive assembly for apparatus 300. In accordance with certain embodiments, release button 312 may comprise a first arm 320a and a second arm 320b. First arm 320a may be coupled to a first threaded portion 316a and second arm 320b may be coupled to a second threaded portion 316b. First threaded portion 316a and second threaded portion 316b may comprise a female threaded surface configured to mechanically interface with a male threaded surface disposed on threaded shaft 304. In accordance with certain aspects of the present disclosure, the interface between threaded shaft 304 and first threaded portion 316a and second threaded portion 316b enables threaded shaft 304 to be driven forwards and backwards in response to rotational motion at hex shank 302. Apparatus 300 may further comprise a retaining ring 322 configured to retain threaded shaft 304 in alignment with first threaded portion 316a and second threaded portion 316b. As shown in FIG. 3C, first threaded portion 316a and second threaded portion 316b may be housed within a retaining portion 318. As shown in FIG. 3D, apparatus 300 may further comprise a spring 318 configured to retain first threaded portion 316a and second threaded portion 316b in contact with between threaded shaft 304. In accordance with certain aspects of the present disclosure, release button 312, in conjunction with first arm 320a and second arm 320b, may be configured to apply downward pressure when depressed by a user in order to displace first threaded portion 316a and second threaded portion 316b by depressing spring 318. This action enables a user to disconnect first threaded portion 316a and second threaded portion 316b in order to release the pressure applied by plunger 306 against a surface of a caulk tube, as well as to enable a user to rapidly retract threaded shaft 304.

As shown in FIG. 3E, apparatus 300 may be operably engaged with power drill 11 to comprise a system. In accordance with certain aspects of the present disclosure, hex shank 302 is operably coupled to chuck 13 of power drill 11. In certain embodiments, hex shank 302 comprises a retaining groove configured to interface with a quick-connect mechanism of an impact driver. Hex shank 302 may comprise a size in the range of a one-quarter inch hex to a three-eighths inch hex in order to accommodate a standard interface with commercial-off-the-shelf power drills and impact drivers. In accordance with certain aspects of the present disclosure, a rotational motion of power drill 11 at chuck 13 is configured to rotate hex shank 302. Hex shank 302 is, in turn, configured to rotate threaded shaft 304. Threaded shaft 304 is thereby threaded through first threaded portion 316a and second threaded portion 316b, as shown in FIG. 3C, to drive plunger 306 forward. Plunger 306 is accordingly configured to apply lateral pressure to a bottom surface of a caulk tube being retained in body portion 308 of apparatus 300. The pressure applied by plunger 306 is thereby configured to force the contents of the caulk tube from an opening of the caulk tube.

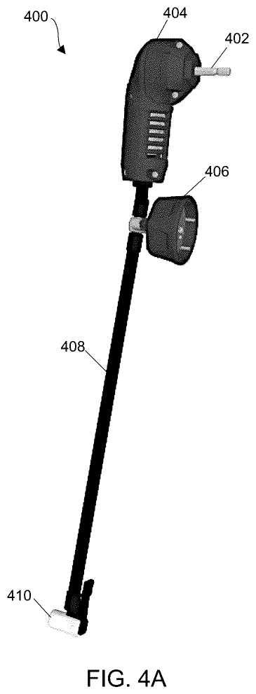

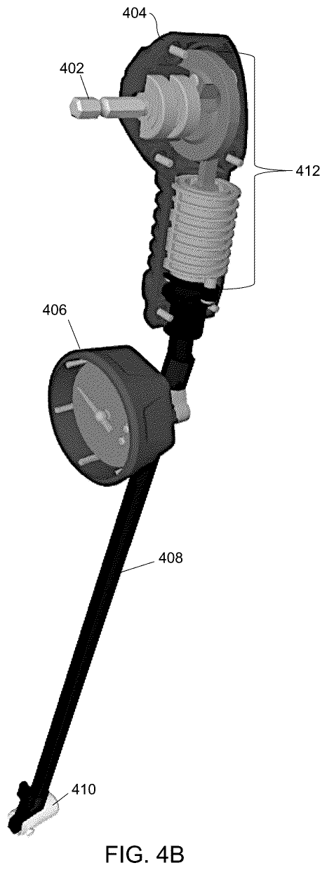

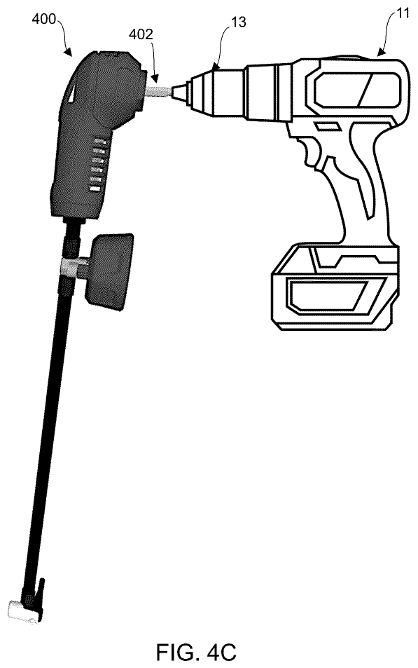

Referring now to FIG. 4A, a perspective view of a drill-powered tire inflator pump apparatus 400 is shown. In accordance with certain aspects of the present disclosure, apparatus 400 comprises a hex shank 402, a pump housing 404, a tire pressure gauge 406, a hose 408, and a tire valve connector 410. As shown in FIG. 4B, apparatus 400 further comprises a pump assembly 412 housed within an internal area of pump housing 404. Pump assembly 412 may comprise a gear assembly configured to drive a piston. In accordance with certain aspects of the present disclosure, hex shank 402 is operably engaged with the gear assembly to drive the piston to create a pressurized flow of air via hose 406. The pressurized flow of air may be delivered to a tire via tire valve connector 410. As shown in FIG. 4C, apparatus 400 may be operably engaged with power drill 11 to comprise a system. In accordance with certain aspects of the present disclosure, hex shank 402 is operably coupled to chuck 13 of power drill 11. In certain embodiments, hex shank 402 comprises a retaining groove configured to interface with a quick-connect mechanism of an impact driver. Hex shank 402 may comprise a size in the range of a one-quarter inch hex to a three-eighths inch hex in order to accommodate a standard interface with commercial-off-the-shelf power drills and impact drivers. In accordance with certain aspects of the present disclosure, a rotational motion of power drill 11 at chuck 13 is configured to rotate hex shank 402. Hex shank 402 is, in turn, configured to engage the gear assembly to drive the piston to create a pressurized flow of air via hose 406. The pressurized flow of air may be delivered to a tire via tire valve connector 410.

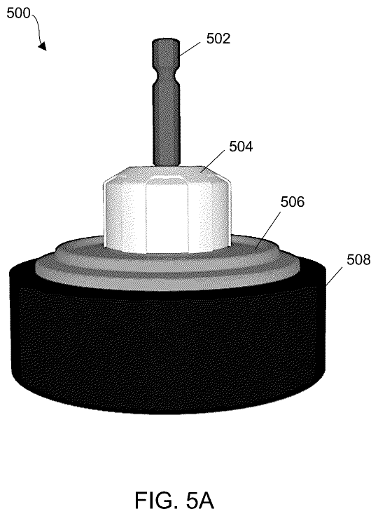

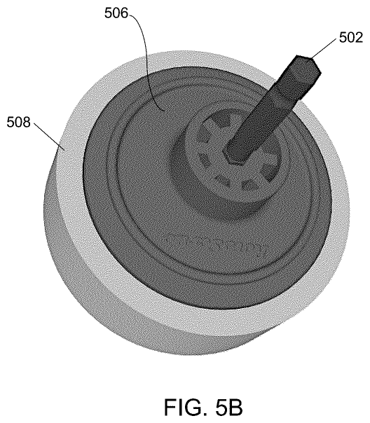

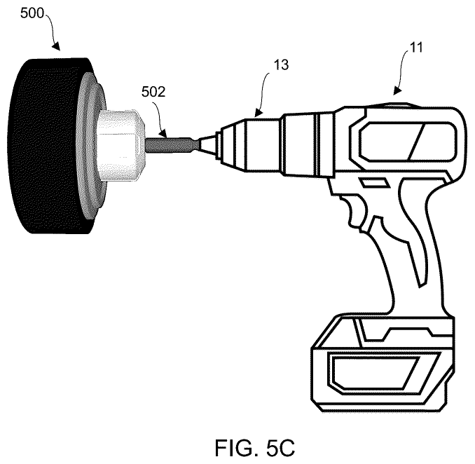

Referring now to FIGS. 5A-5B, perspective views of a scrubbing pad apparatus 500 for a power drill are shown. In accordance with certain aspects of the present disclosure, apparatus 500 may comprise a hex shank 502, a collar portion 504, a body portion 506, and a scrubbing pad portion 508. In accordance with certain embodiments, collar portion 504 may be configured to freely spin around hex shank 502. Collar portion 504 may be configured to freely spin on an upper surface of body portion 506. As shown in FIG. 5B, body portion 506 may have a raised portion configured to interface with collar portion 504. As shown in FIG. 5C, apparatus 500 may be operably engaged with power drill 11 to comprise a system. In accordance with certain aspects of the present disclosure, hex shank 502 is operably coupled to chuck 13 of power drill 11. In certain embodiments, hex shank 502 comprises a retaining groove configured to interface with a quick-connect mechanism of an impact driver. Hex shank 502 may comprise a size in the range of a one-quarter inch hex to a three-eighths inch hex in order to accommodate a standard interface with commercial-off-the-shelf power drills and impact drivers. In accordance with certain aspects of the present disclosure, a rotational motion of power drill 11 at chuck 13 is configured to rotate hex shank 502. Hex shank 502 is, in turn, configured to rotate body portion 506 and scrubbing pad portion 508 to generate a rotational cleaning action via scrubbing pad portion 508. In accordance with certain embodiments, a user may hold collar portion 504 while hex shank 502 is spinning in order to stabilize body portion 506 and scrubbing pad portion 508 during use.

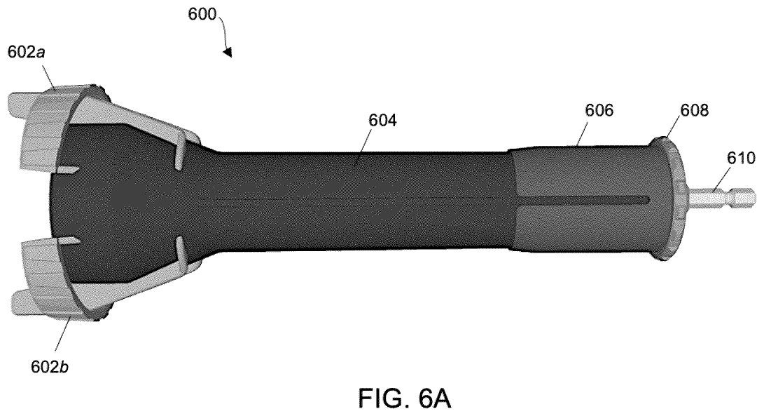

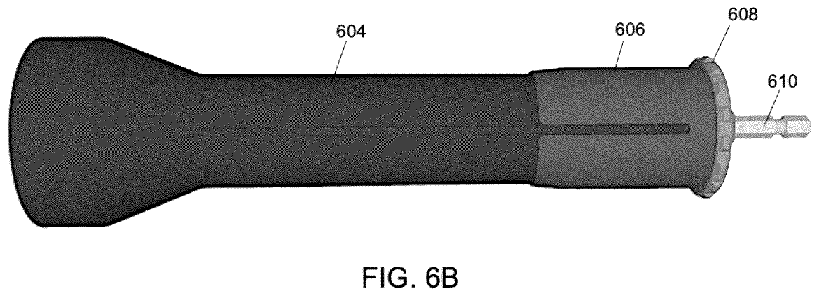

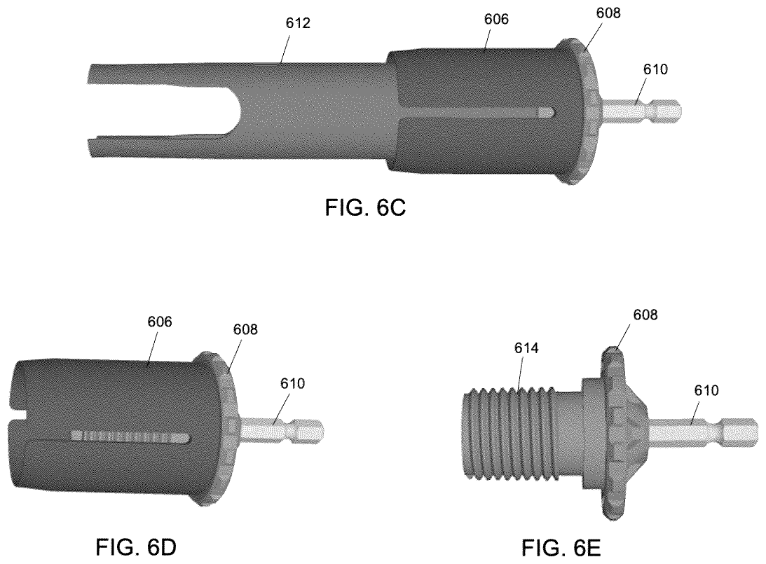

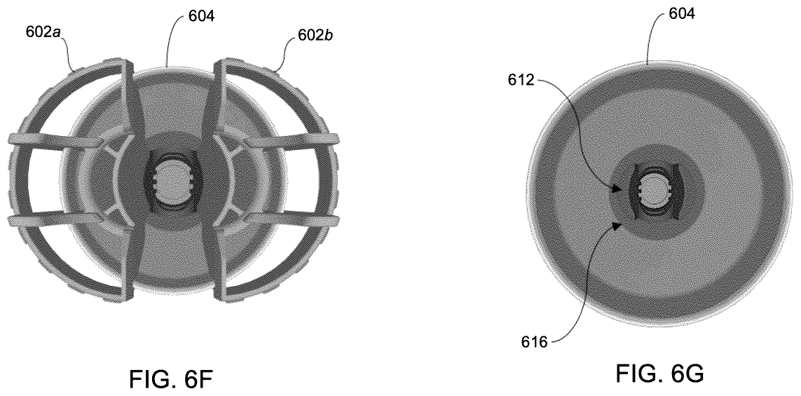

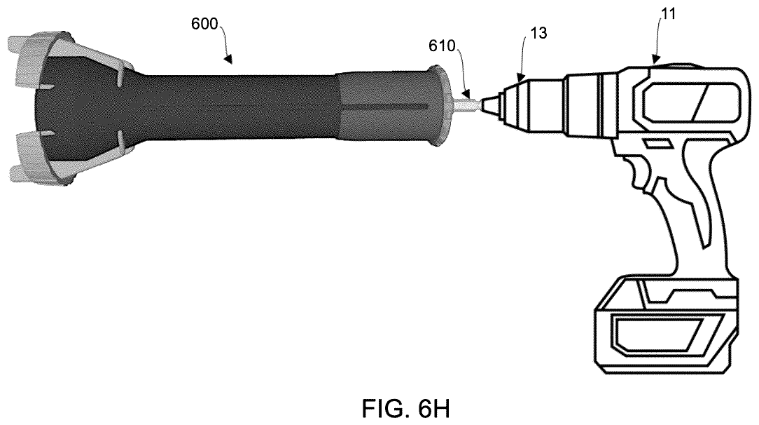

Referring now to FIG. 6A, a perspective view of a painting tool apparatus 600 for use with a power drill is shown. In accordance with certain aspects of the present disclosure, apparatus 600 may comprise a first paint mixer portion 602a and a second paint mixer portion 602b, a paint roller portion 604, a body portion 606, a base portion 608 and a hex shank 610. In certain embodiments, hex shank 610 comprises a retaining groove configured to interface with a quick-connect mechanism of an impact driver. Hex shank 610 may comprise a size in the range of a one-quarter inch hex to a three-eighths inch hex in order to accommodate a standard interface with commercial-off-the-shelf power drills and impact drivers. As shown in FIG. 6A, apparatus 600 may be configured in a first configuration for a paint mixing function. In certain embodiments, first paint mixer portion 602a and second paint mixer portion 602b may be configured to be removably coupled to a surface of paint roller portion 604. First paint mixer portion 602a and second paint mixer portion 602b may comprise ribs or paddles configured to effect a stirring/mixing action when apparatus 600 is rotationally engaged in a paint container. As shown in FIG. 6B, apparatus 600 may be configured in a second configuration for a paint roller cleaning function. In certain embodiments, paint roller portion 604 may comprise a cylindrical portion having a diameter in the range of about 1.5 inches to about 1.75 inches. Paint roller portion 604 may comprise a flared portion at a distal end, which may increase in size to a diameter in the range of about 2.5 inches to about 3.5 inches. In accordance with certain embodiments, paint roller portion 604 is configured to receive a standard sized paint roller on the cylindrical portion. The flared portion is configured to retain paint roller portion 604 on the cylindrical portion. In accordance with certain embodiments, paint roller portion 604 is removably coupled to body portion 606. In some embodiments, paint roller portion 604 may be friction-fit with body portion 606. In accordance with certain embodiments, body portion 606 comprises a diameter in the range of about 1.5 inches to about 1.75 inches to receive a standard size paint roller. As shown in FIG. 6C, apparatus 600 may further comprise a brush holder portion 612. Brush holder portion 612 may comprise a receiving portion configured to receive and retain a handle of a paintbrush. Brush holder portion 612 may be configured to retain a handle of a paintbrush via a friction-fit interface. In accordance with certain embodiments, brush holder portion 612 may be nested inside of paint roller portion 604 when paint roller portion 604 is interfaced with body portion 606. As shown in FIGS. 6D-6E, base portion 608 may further comprise a threaded portion 614. Threaded portion 614 may be configured to interface with brush holder portion 612 to securely couple brush holder portion 612 to base portion 608. FIGS. 6F-6G illustrate bottom plan views of apparatus 600. In accordance with certain embodiments, FIG. 6F illustrates a design of first paint mixer portion 602a and second paint mixer portion 602b. In accordance with certain embodiments, paint roller portion 604 may have an open bottom portion 616 configured to receive a paintbrush handle therethrough and enable an interface between a paintbrush handle and brush holder portion 612.

As shown in FIG. 6H, apparatus 600 may be operably engaged with power drill 11 to comprise a system. In accordance with certain aspects of the present disclosure, hex shank 610 is operably coupled to chuck 13 of power drill 11. In certain embodiments, hex shank 610 comprises a retaining groove configured to interface with a quick-connect mechanism of an impact driver. Hex shank 610 may comprise a size in the range of a one-quarter inch hex to a three-eighths inch hex in order to accommodate a standard interface with commercial-off-the-shelf power drills and impact drivers. In accordance with certain aspects of the present disclosure, a rotational motion of power drill 11 at chuck 13 is configured to rotate hex shank 610. Hex shank 610 is, in turn, configured to rotate apparatus 600 around an axis of hex shank 610 to generate a rotational cleaning action or a paint mixing action, according to the configuration of apparatus 600.

The terminology used herein is for describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,”, and variants thereof, when used herein, specify the presence of stated features, steps, operations, elements, and/or components, but do not preclude the presence or addition of one or more other features, steps, operations, elements, components, and/or groups thereof. As used herein, “exemplary” means serving as an example or illustration and does not necessarily denote ideal or best.

It will be understood that when an element is referred to as being “coupled,” “connected,” or “responsive” to another element, it can be directly coupled, connected, or responsive to the other element, or intervening elements may also be present. In contrast, when an element is referred to as being “directly coupled,” “directly connected,” or “directly responsive” to another element, there are no intervening elements present. As used herein, the term “and/or” includes any and all combinations of one or more of the associated listed items.

Spatially relative terms, such as “above,” “below,” “upper,” “lower,” “top, “bottom,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly. Well-known functions or constructions may not be described in detail for brevity and/or clarity.

It will be understood that, although the terms “first,” “second,” etc. may be used herein to describe various elements, these elements should not be limited by these terms. These terms are only used to distinguish one element from another. Thus, a first element could be termed a second element without departing from the teachings of the present embodiments. Unless otherwise defined, all terms (including technical and scientific terms) used herein have the same meaning as commonly understood by one of ordinary skill in the art to which these embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The present disclosure includes that contained in the appended claims as well as that of the foregoing description. Although this invention has been described in its exemplary forms with a certain degree of particularity, it is understood that the present disclosure of has been made only by way of example and numerous changes in the details of construction and combination and arrangement of parts may be employed without departing from the spirit and scope of the invention. Therefore, it will be apparent to those skilled in the art that various modifications and variations can be made to the disclosed embodiments without departing from the scope or spirit of the invention. In view of the foregoing. it is intended that the invention covers modifications and variations of this disclosure within the scope of the following claims and their equivalents.

What is claimed is:

1. A power cleaner apparatus comprising:
a housing portion;
a pump casing housed inside the housing portion, wherein the pump casing comprises a water inlet, a water outlet and an internal chamber configured to receive a volume of water therein;
a hose connector portion coupled to the housing portion, wherein the hose connector portion is configured to deliver a flow of water to the internal chamber of the pump casing;
a hex shank extending through a surface of the housing portion, wherein the hex shank is configured to interface with a chuck of a power drill,
wherein the hex shank is configured to rotate 360 degrees in response to rotary motion applied by the power drill;
an impeller operably engaged with the hex shank and housed in the internal chamber of the pump casing,
wherein the hex shank is configured to rotate the impeller 360 degrees,
wherein the impeller is configured to force the volume of water from the internal chamber of the pump casing through the water outlet when the impeller is rotated by the hex shank; and
a nozzle portion comprising a channel portion extending from a first end to a second end, wherein the nozzle portion is coupled to the housing portion and configured to receive a pressurized flow of water from the water outlet of the pump casing at the first end and output the pressurized flow of water at the second end.

2. The power cleaner apparatus of claim 1 further comprising a water tube removably coupled to the hose connector portion.

3. The power cleaner apparatus of claim 1 wherein the nozzle portion further comprises a radial dial disposed on the second end and comprising a plurality of different nozzles configured to receive the pressurized flow of water therethrough.

4. The power cleaner apparatus of claim 3 wherein each nozzle in the plurality of different nozzles comprises a different spray pattern.

5. The power cleaner apparatus of claim 1 wherein the hex shank comprises a retaining groove configured to interface with an impact driver.

6. The power cleaner apparatus of claim 1 wherein the impeller is configured to generate a negative pressure at the water inlet of the pump casing when rotated by the hex shank.

7. The power cleaner apparatus of claim 1 wherein the impeller is configured to generate a variable pressure in the internal chamber of the pump casing according to a speed of rotation of the hex shank.

8. The power cleaner apparatus of claim 1 wherein the hex shank comprises a size in the range of a one-quarter inch hex to a three-eighths inch hex.

9. The power cleaner apparatus of claim 1 wherein the nozzle portion is removably coupled to the housing portion via a mateable interface.

10. A power cleaner system comprising:
an apparatus comprising:
a housing portion;
a pump casing housed inside the housing portion, wherein the pump casing comprises a water inlet, a water outlet and an internal chamber configured to receive a volume of water therein;
a hose connector portion coupled to the housing portion, wherein the hose connector portion is configured to deliver a flow of water to the internal chamber of the pump casing;
a hex shank extending through a surface of the housing portion;
an impeller operably engaged with the hex shank and housed in the internal chamber of the pump casing,
wherein the hex shank is configured to rotate the impeller 360 degrees,
wherein the impeller is configured to force the volume of water from the internal chamber of the pump casing through the water outlet when the impeller is rotated by the hex shank; and
a nozzle portion comprising a channel portion extending from a first end to a second end, wherein the nozzle portion is coupled to the housing portion and configured to receive a pressurized flow of water from the water outlet of the pump casing at the first end and output the pressurized flow of water at the second end; and
a power drill comprising a chuck configured to receive and retain the hex shank,
wherein the power drill is configured to rotate the hex shank via a rotational drive at the chuck.

11. The power cleaner system of claim 10 further comprising a water tube removably coupled to the hose connector portion.

12. The power cleaner system of claim 10 wherein the nozzle portion further comprises a radial dial disposed on the second end and comprising a plurality of different nozzles configured to receive the pressurized flow of water therethrough.

13. The power cleaner system of claim 12 wherein each nozzle in the plurality of different nozzles comprises a different spray pattern.

14. The power cleaner system of claim 10 wherein the hex shank comprises a retaining groove configured to interface with an impact driver.

15. The power cleaner system of claim 10 wherein the impeller is configured to generate a negative pressure at the water inlet of the pump casing when rotated by the hex shank.

16. The power cleaner system of claim 10 wherein the impeller is configured to generate a variable pressure in the internal chamber of the pump casing according to a speed of rotation of the hex shank.

17. The power cleaner system of claim 10 wherein the hex shank comprises a size in the range of a one-quarter inch hex to a three-eighths inch hex.

18. The power cleaner system of claim 10 wherein the nozzle portion is removably coupled to the housing portion via a mateable interface.

19. The power cleaner system of claim 10 wherein the hose connector portion comprises a quick connect garden hose fitting.

20. A power cleaner apparatus comprising:
a housing portion comprising a water inlet, a water outlet and an internal chamber configured to receive a volume of water therein;
a hex shank extending through a surface of the housing portion,
wherein the hex shank is configured to interface with a chuck of a power drill,
wherein the hex shank is configured to rotate 360 degrees in response to rotary motion applied by the power drill;
an impeller operably engaged with the hex shank and housed in the internal chamber of the housing portion,
wherein the hex shank is configured to rotate the impeller 360 degrees,
wherein the impeller is configured to force the volume of water from the internal chamber of the housing portion through the water outlet when the impeller is rotated by the hex shank; and
a nozzle portion coupled to the housing portion and configured to direct a pressurized flow of water from the water outlet at a nozzle tip.
